(19) United States
(12) Patent Application Publication
(10) Pub. No.: US 2012/0173809 A1
(43) Pub. Date: Jul. 5, 2012

(54) Memory Device Having DRAM Cache and System Including the Memory Device

(76) Inventor: Tae-Kyeong Ko, Hwaseong-si (KR)

(21) Appl. No.: 13/344,150

(22) Filed: Jan. 5, 2012

(30) Foreign Application Priority Data
Jan. 5, 2011 (KR) 10-2011-0001012

(51) Int. Cl. G06F 12/00

(52) U.S. Cl. 711/105; 711/E12.001

(57) ABSTRACT

The present disclosure relates to a memory device and a system including the memory device. The memory device may include a non-volatile memory, a dynamic random access memory (DRAM) cache, a DRAM, and a control circuit. The control circuit may perform interfacing between the DRAM and a host, between the DRAM cache and the host, and between the non-volatile memory and the DRAM cache. The memory device may have a high operating speed and may be incorporated in a simple package, such as a multi-chip package.

### CROSS-REFERENCE TO RELATED APPLICATION

This application claims priority under 35 U.S.C. §119 to Korean Patent Application No. 10-2011-0001012 filed on Jan. 5, 2011, the disclosure of which is hereby incorporated by reference in its entirety.

### BACKGROUND

Embodiments of the present disclosure relate to a memory device and a system including the same.

Memory devices are being developed in the form of a multi-chip package (MCP) in which a volatile memory device and a non-volatile memory device are included in one package.

### SUMMARY

In one embodiment, an exemplary memory device comprises a non-volatile memory, a DRAM cache, a DRAM, and a control circuit configured to interfacing between the DRAM and a host, between the DRAM cache and the host, and between the non-volatile memory and the DRAM cache.

In one embodiment, an exemplary system comprises a host and a memory device, wherein the memory device includes a non-volatile memory, a DRAM cache, a DRAM, and a control circuit configured to interfacing between the DRAM and the host, between the DRAM cache and the host, and between the non-volatile memory and the DRAM cache.

In one embodiment, an exemplary multi-chip memory device package comprises a DRAM, a non-volatile memory, and a first controller configured to receive a physical address and a command, and to interface with one of the DRAM and the non-volatile memory based on the physical address. In this embodiment, each one of the physical addresses in a DRAM physical address space of the DRAM corresponds to a respective virtual address in a first part of a virtual address space in a host, and each one of the physical addresses in a flash physical address space corresponds to a respective one of the virtual addresses in a second part of the virtual address space of the host.

### BRIEF DESCRIPTION OF THE DRAWINGS

The above and other features and aspects of the disclosure will become more apparent by describing in detail exemplary embodiments thereof with reference to the attached drawings, in which:

FIG. 1 is a block diagram of a system including a memory device according to an exemplary embodiment;

FIG. 2 is a block diagram of an example of a host included in the system of FIG. 1;

FIG. 3 is a block diagram of an example of a memory device included in the system of FIG. 1;

FIG. 4A is a block diagram showing an example of addresses transferred between chips in the system of FIG. 1;

FIG. 4B is a block diagram showing an example of addresses transferred between chips in the system of FIG. 1;

FIG. 5 is a diagram illustrating an example of data mapping between a host and a memory device;

FIG. 6 is a block diagram of another example of the memory device included in the system of FIG. 1;

FIG. 7 is a block diagram of still another example of the memory device included in the system of FIG. 1;

FIG. 8 is a diagram of yet another example of the memory device included in the system of FIG. 1;

FIG. 9 is a block diagram of a system including a memory device according to another exemplary embodiment;

FIG. 10 is a flowchart illustrating a data read method of a memory device according to an exemplary embodiment; and

FIG. 11 is a flowchart illustrating a data write method of a memory device according to an exemplary embodiment.

### DETAILED DESCRIPTION OF THE EMBODIMENTS

The present disclosure will now be described below in more detail with reference to the accompanying drawings, in which various embodiments are shown. The invention may, however, be embodied in many different forms and should not be construed as limited to the embodiments set forth herein.

It will be understood that when an element or layer is referred to as being “on,” “connected to” or “coupled with” another element or layer, it can be directly on, connected or coupled with the other element or layer or intervening elements or layers may be present. In contrast, when an element is referred to as being “directly on,” “directly connected to” or “directly coupled with” another element or layer, there are no intervening elements or layers present. Like numerals refer to like elements throughout. In the drawings, the sizes and relative sizes of layers and regions are exaggerated for clarity of illustration. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. Unless indicated otherwise, these terms are only used to distinguish one element, component, region, layer or section from another region, layer or section. Thus, a first element, component, region, layer or section discussed below could be termed a second element, component, region, layer or section, and, similarly, a second element, component, region, layer or section discussed below could be termed a first element, component, region, layer or section without departing from the teachings of the disclosure.

The terminology used herein is for the purpose of describing particular embodiments only and is not intended to be limiting of the invention. As used herein, the singular forms “a,” “an” and “the” should not exclude the plural forms as well, unless the context clearly indicates otherwise. It will be further understood that the terms “comprises” and/or “comprising” or “includes” or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In some alternative implementations, the functions/acts noted in the blocks may occur out of the order noted in the flowcharts. For example, two blocks shown in succession may in fact be executed substantially concurrently or the blocks may sometimes be executed in the reverse order, depending upon the steps/acts involved.

Hereinafter, embodiments of the present disclosure will be more fully described with reference to the accompanying drawings.

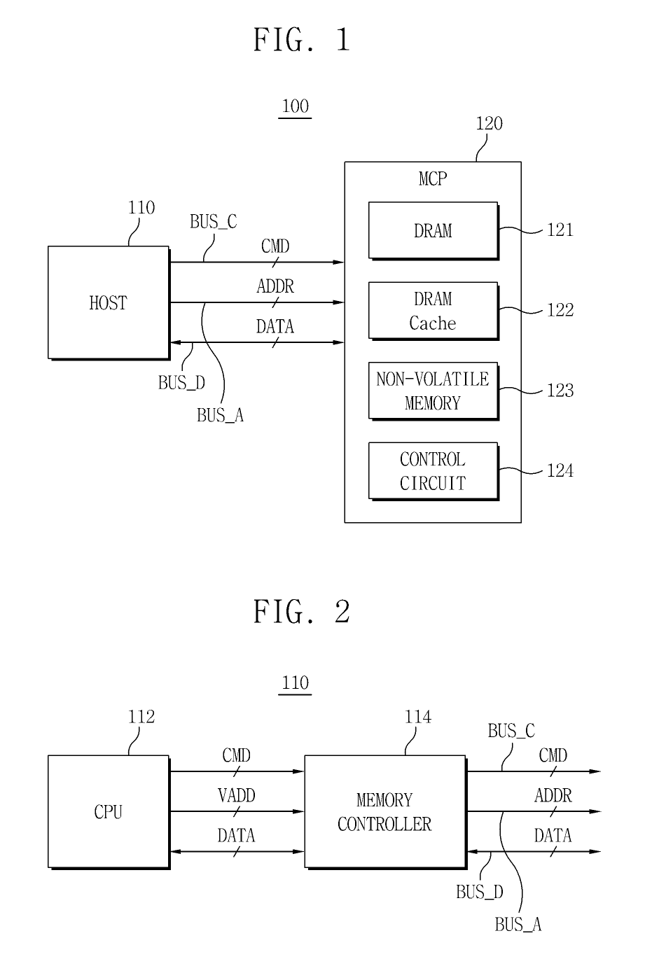

FIG. 1 is a block diagram of a system 100 including a memory device according to an example embodiment.

Referring to FIG. 1, the system 100 includes a host 110 and a memory device 120.

The host 110 generates a command CMD, an address ADDR, and data DATA. After the command CMD, the address ADDR, and the data DATA are received from the host 110 via a command bus BUS_C, an address bus BUS_A, and a data bus BUS_D respectively, the memory device 120 writes the data DATA to a memory space corresponding to the address ADDR, or reads data from the memory space corresponding to the address ADDR, and transmits the read data to the host 110. The memory device 120 may include a dynamic random access memory (DRAM) 121, a DRAM cache 122, a non-volatile memory 123, and a control circuit 124.

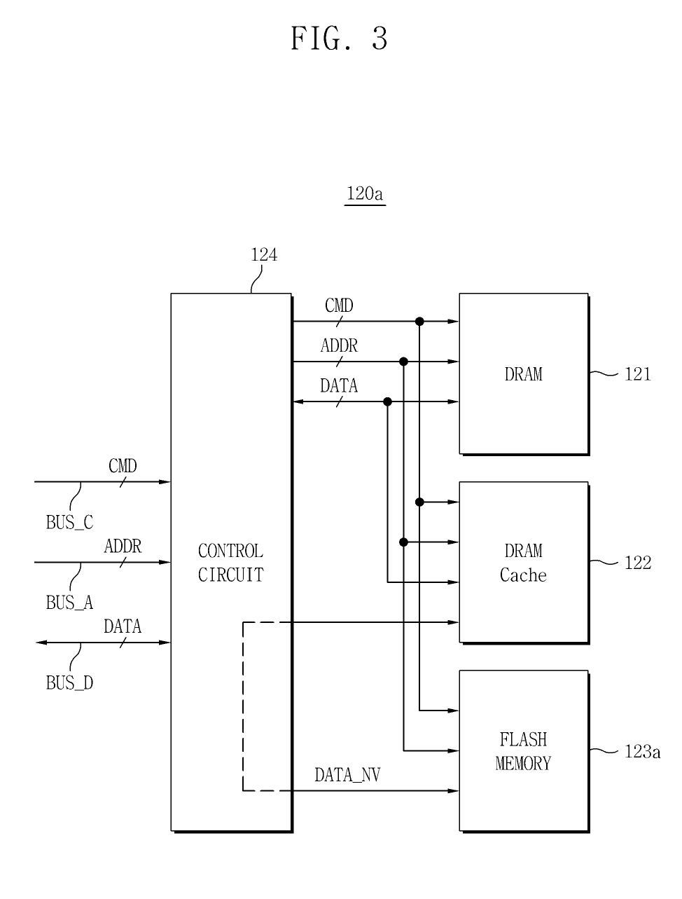

FIG. 2 is a block diagram of an example of the host 110 included in the system 100 of FIG. 1. Referring to FIG. 2, the host 110 may include a central processing unit (CPU) 112 and a memory controller 114. The memory controller 114 may be for controlling a DRAM.

The CPU 112 generates the command CMD, a virtual address VADD, and the data DATA. The memory controller 114 receives the command CMD, the virtual address VADD, and the data DATA, generates the address ADDR on the basis of the virtual address VADD, and outputs the command CMD, the address ADDR, and the data DATA via the command bus BUS_C, the address bus BUS_A, and the data bus BUS_D respectively. The memory controller 114 may perform memory mapping between the host 110 and the memory device 120. In one embodiment, a first portion of a virtual memory space in the host 110 may be mapped to the physical address space of the DRAM 121 of the memory device 120. In this embodiment, a second portion of the virtual memory space in the host 110 may be mapped to the flash memory 123 of the memory device 120. In some embodiments, the flash memory 123 may use a DRAM cache 122 when engaging in data processing functions with the host 110.

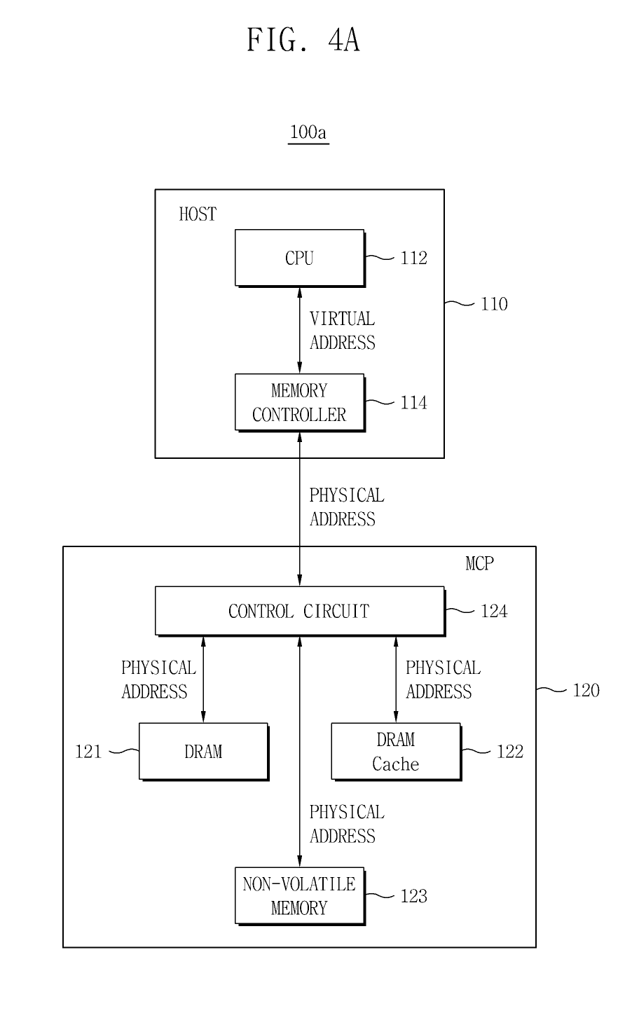

FIG. 3 is a block diagram of an example of a memory device 120a included in the system 100 of FIG. 1.

Referring to FIG. 3, a memory device 120a may include a DRAM 121, a DRAM cache 122, a flash memory 123a, and a control circuit 124. In one embodiment, the DRAM 121, the DRAM cache 122, the flash memory 123a, and the control circuit 124 are separate semiconductor chips, and the memory device 120a is a multi-chip package (MCP). In one embodiment, each of the DRAM 121, the DRAM cache 122, and the flash memory 123a may include one or more chips. In this embodiment, each of the DRAM 121, the DRAM cache 122, and the flash memory 123a may include a 3-dimensional stack of chips. The DRAM 121 and the DRAM cache 122 are volatile semiconductor memories, and the flash memory 123a is a non-volatile semiconductor memory. The control circuit 124 may be an application-specific integrated circuit (ASIC) chip. The control circuit 124 may be a separate semiconductor chip, or it may be part of another semiconductor chip in the MCP.

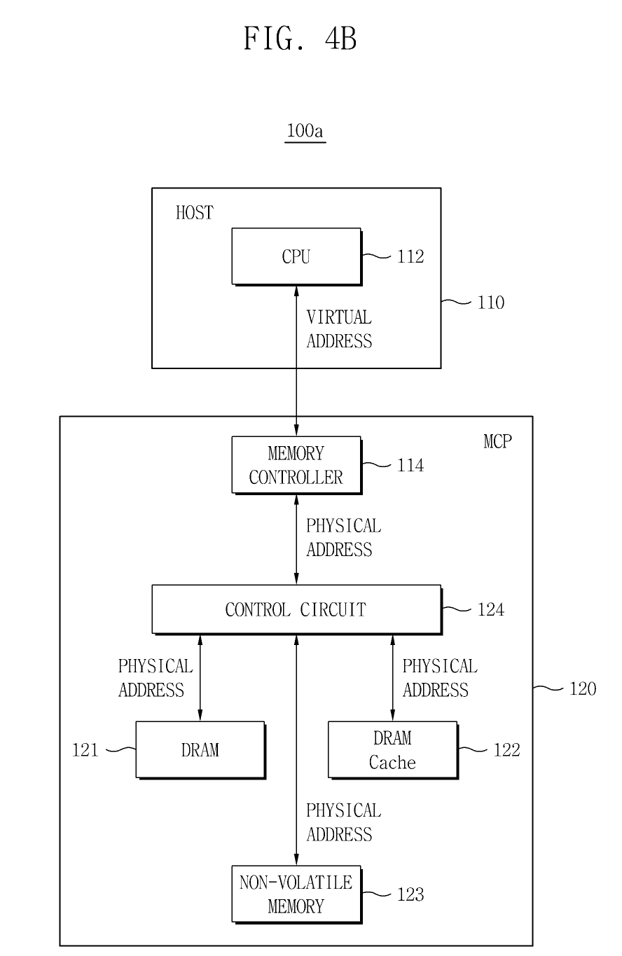

In some embodiments, and as shown in FIG. 4B, the memory device 120a may also include the memory controller 114. The memory controller 114 may be a separate chip. In one embodiment, the memory controller 114 and the control circuit 124 may be implemented as one chip. In one embodiment, the memory controller 114 and the control circuit 124 may be part of another semiconductor chip in the MCP.

The control circuit 124 serves as an interface between the DRAM 121 and the host (110 of FIG. 1), between the DRAM cache 122 and the host 110, and between the flash memory 123a and the DRAM cache 122. In one embodiment, the control circuit 124 includes circuitry and structure to manage both a DRAM memory and a flash memory. In one embodiment, the control circuit 124 includes pads and buffers to input and output signals and data to and from the control circuit 124. For example, the control circuit 124 may include a pad for receiving a CMD from the host 110, as well as a buffer and circuitry to process the CMD.

The control circuit 124 may also include, for example, timing and clock cycle management for both DRAM and flash memory interfacing and processing, garbage collection, wear-leveling and bad block management circuitry for the flash memory, and error correction circuitry. The timing and clock cycle management circuitry may enable the flash memory 123a and/or the DRAM 121 to operate in a synchronized fashion with the clock cycles of a host. The timing and clock cycle management circuitry may enable the flash memory 123a and/or the DRAM 121 to synchronize their own operations with an internal clock and manage the execution of internal instruction and processes. The wear-leveling circuitry may enable the flash memory 123a to associate a logical address with more than one physical address. This may enable the flash memory 123a to update data for a logical address without having to erase the entire block containing the physical address associated with the logical address. Bad block management circuitry may enable the flash memory to recognize blocks that contain defects or other problems such that the flash memory 123a may not want to store data in those “bad blocks.” The bad block management circuitry may enable the flash memory 123a to skip over “bad blocks” when writing data to the flash memory 123a. The garbage collection circuitry may erase data in blocks of the flash memory 123a in which all of the data has been labeled as invalid and make the erased blocks available for writing. The error correction circuitry may detect errors on data read from the DRAM and the flash memory 123a. Additionally, the control circuit 124 may include the structure and circuitry to determine whether an address received from an external host is associated with the DRAM 121 or the flash memory 123a.

An example of a DRAM memory controller is shown in U.S. Pat. No. 7,450,441, which is incorporated herein by reference. An example of a memory controller for flash memory is shown in U.S. Pat. No. 7,826,263, which is incorporated herein by reference. The structure and circuitry of the control circuit 124 is not limited to the examples or to combinations of the examples described above.

For example, when the control circuit 124 receives a command CMD and address ADDR from the host 110, the control circuit may determine whether the received address ADDR is associated with the DRAM 121 or the flash memory 123a. The control circuit 124 may include a lookup table for the addresses, or may be able to determine by the physical address itself if the received address ADDR is in the physical address space associated with the DRAM 121 or the physical address space of the flash memory 123a.

In another example, the control circuit 124 may send the received physical address ADDR to both the flash memory 123a and the DRAM 121. In this embodiment, the DRAM 121 and the flash memory 123a receive the address ADDR. The DRAM 121, for example, may receive the address ADDR, and if the address is within the physical address space of the DRAM 121, the DRAM 121 may process the address according to the received command CMD. Similarly, the flash memory 123a, for example, may receive the address ADDR, and if the address is within the physical address space of the flash memory 123a, the flash memory 123a may process the address according to the received command CMD.

In one embodiment, the control circuit 124 receives the command CMD, the address ADDR, and the data DATA via the command bus BUS_C, the address bus BUS_A, and the data bus BUS_D respectively, and provides the received command CMD, address ADDR, and data DATA to the DRAM 121 and the DRAM cache 122. In one embodiment, the control circuit 124 provides the command CMD and the address ADDR to the flash memory 123a, and transfers data DATA_NV between the flash memory 123a and the DRAM cache 122. In one embodiment, the control circuit 124 performs interfacing between the DRAM 121 and the host 110, between the DRAM cache 122 and the host 110, and between the flash memory 123a and the DRAM cache 122. In one embodiment, data is read and written to the DRAM cache 122 in conjunction with data processing requests from the host directed to the flash memory 123a, and the flash memory 123a is periodically updated. The use of the DRAM cache 122 with the flash memory 123a may prolong the life of the flash memory 123a and may reduce the number of instances in which to perform, for example, garbage collection, bad block management, and/or wear leveling in the flash memory 123a.

In one embodiment, the control circuit 124 interfaces directly with both the DRAM 121 and the flash memory 123a. In this embodiment, the DRAM cache 122 is not used. For example, the control circuit 124 may receive the command CMD, the address ADDR, and the data DATA via the command bus BUS_C, the address bus BUS_A, and the data bus BUS_D respectively, and may provide the received command CMD, address ADDR, and data DATA to the DRAM 121 and the flash memory 123a. In this example, the control circuit 124 performs interfacing between the DRAM 121 and the host 110, and between the flash memory 123a and the host 110.

FIG. 4 is a block diagram showing an example of addresses transferred between chips in an exemplary system 100a, similar to the system of FIG. 1.

Referring to FIGS. 4A and 4B, the memory controller 114 of the host 110 receives a virtual address from the CPU 112 and generates a physical address on the basis of the virtual address. The control circuit 124 included in the memory device 120 receives the physical address from the memory controller 114 of the host 110 and provides the physical address to the DRAM 121, the DRAM cache 122, and the flash memory 123a. The memory controller 114 may be provided in the host, as shown in FIG. 4A, or may be provided in the memory device 120, as shown in FIG. 4B. In an embodiment where the memory controller 114 is provided in the memory device 120, the memory controller 114 may be part of the same circuitry and/or semiconductor chip as the control circuit 124 or may be part of different circuitry and/or a different semiconductor chip than the control circuit 124.

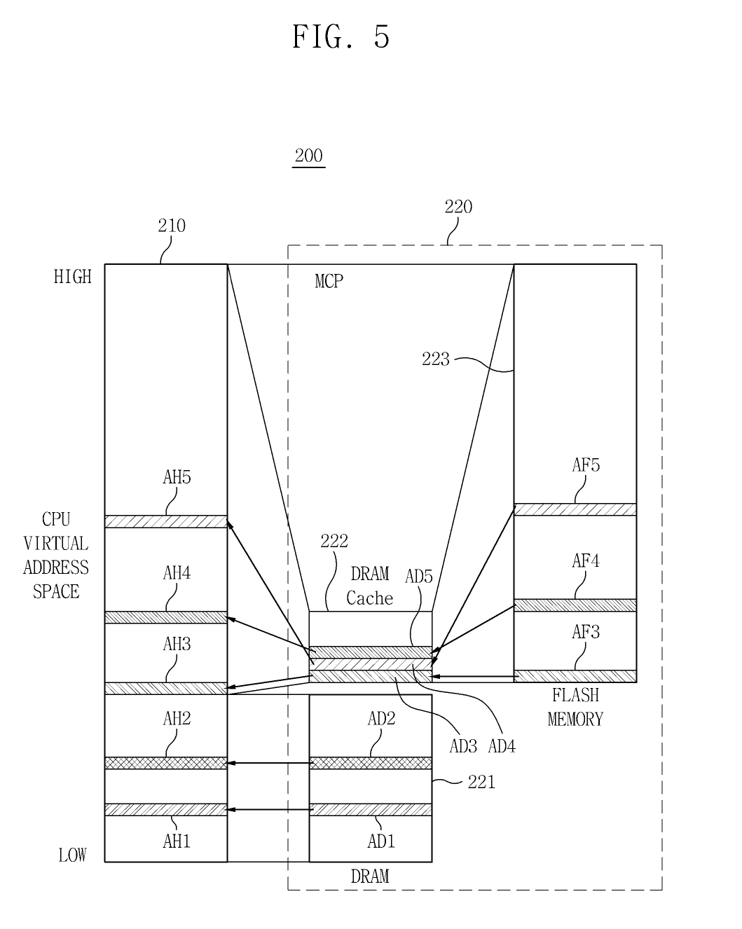

FIG. 5 is a diagram illustrating an example of data mapping between a host 210 and a memory device 220 in an exemplary system 200. FIG. 5 illustrates a process of mapping data between a virtual address space of a CPU of the host 210 and a DRAM 221, a DRAM cache 222, and a flash memory 223. In FIG. 5, the host 210, the DRAM 221, the DRAM cache 222, and the flash memory 223 correspond to the host 110, the DRAM 121, the DRAM cache 122, and the non-volatile memory 123a of FIG. 1, respectively.

Referring to FIG. 5, a first part of the virtual address space of the CPU 212 of the host 210 is directly mapped to a physical address space of the DRAM 221. For example, a physical address area AD1 of the DRAM 221 is mapped to a virtual address area AH1 of the CPU 212, and a physical address area AD2 of the DRAM 221 is mapped to a virtual address area AH2 of the CPU 212. A direct mapping of the virtual address space of the CPU 212 and the physical address space of the DRAM 221 may indicate that, for each virtual address stored in the CPU 212 of the host 210, there is a corresponding physical address that may contain data in the DRAM 221. In one embodiment, there is a 1:1 correspondence between the virtual addresses in the virtual address area AH1 and the physical addresses in the physical address area AD1. In this embodiment, there is also a 1:1 correspondence between the virtual addresses in the virtual address AH2 and the physical addresses in the physical address area AD2. A 1:1 correspondence between virtual addresses in a virtual address space and physical addresses in a physical address space may mean that for each virtual address in a virtual address space, there is one corresponding physical address in the physical address space.

In one embodiment, the virtual address space of the CPU 112 of the host 110 is not directly mapped to a physical address space of the flash memory 223. In one embodiment, the virtual address space of the CPU 212 of the host 210 is mapped to a physical address space of the flash memory 223 through a physical address space of the DRAM cache 222. For example, the virtual address areas AH3, AH4, and AH5 of the CPU 212 are mapped to physical address areas AD3, AD4 and ADS of the DRAM cache 222, respectively. Physical address areas AD3, AD4 and ADS of the DRAM cache 222 are mapped to physical address areas AF3, AF4 and AF5 of the flash memory 223, respectively. In this embodiment, the CPU 212 may not directly interface with the flash memory 223. In this embodiment, each of the physical addresses in the physical address space of the DRAM cache 222 may be in the physical address space of the flash memory 223.

In one embodiment, the virtual address space AH3, AH4, and AH5 of the CPU 212 maintains a one-to-one correspondence with the physical address space AF3, AF4, and AF5, respectively, of the flash memory 223. For example, there is a 1:1 correspondence between the virtual addresses in the virtual address area AH3 and the physical addresses in the physical address area AD3. In this embodiment, there is also a 1:1 correspondence between the virtual addresses in the virtual address AH4 and the physical addresses in the physical address area AD4, as well as a 1:1 correspondence between the virtual addresses in the virtual address area AH5 and the physical addresses in the physical address area AD5. In this embodiment, the virtual address space of the CPU 212 may remain indirectly mapped to a physical address space of the flash memory 223 as described above.

A direct mapping of the virtual and physical address spaces in the host 110 and the memory device 120 may not necessarily require a specific type of address allocation scheme (i.e. direct, fully associative, or n-way set address allocation) between the address spaces. The type of address allocation scheme used for relating the virtual and physical addresses in the host 110 and the memory device 120 are not limited to the examples described herein.

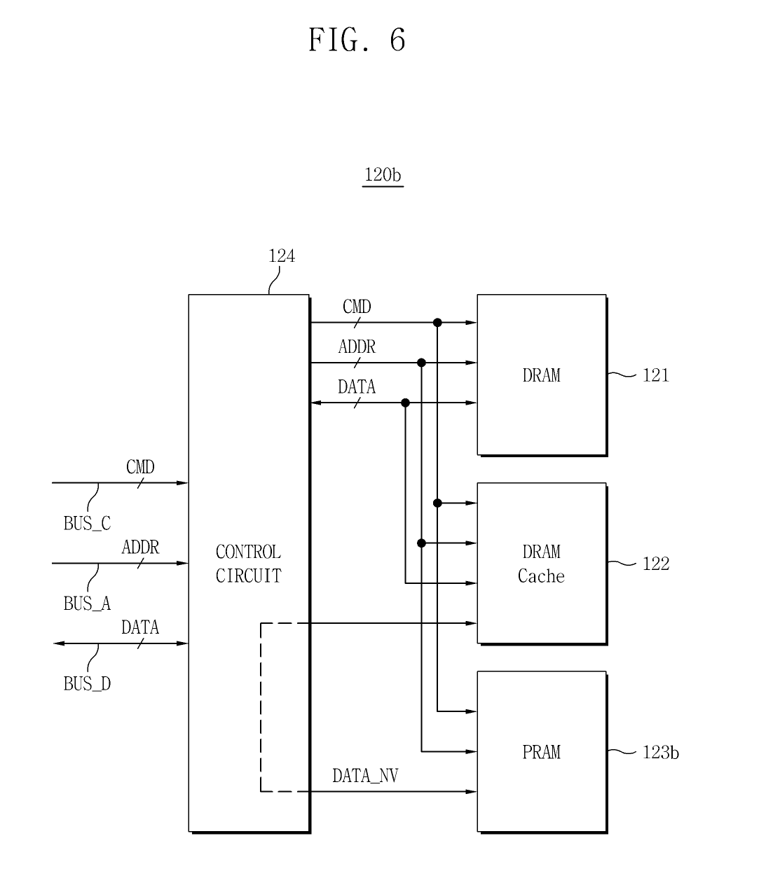

FIG. 6 is a block diagram of another example of a memory device 120b included in the system 100 of FIG. 1.

Referring to FIG. 6, a memory device 120b may include a DRAM 121, a DRAM cache 122, a phase-change RAM (PRAM) 123b, and a control circuit 124. In one embodiment, the DRAM 121, the DRAM cache 122, the PRAM 123b, and the control circuit 124 are separate semiconductor chips, and the memory device 120b is an MCP. For example, the DRAM 121 and the DRAM cache 122 may be volatile semiconductor memories, and the PRAM 123b may be a resistive memory device that employs a phase-change material as a variable resistance device. In one embodiment, the PRAM 123b is a non-volatile memory device. The control circuit 124 may be an ASIC chip.

The control circuit 124 serves as an interface between the DRAM 121 and the host (e.g. host 110 of FIG. 1), between the DRAM cache 122 and the host, and between the PRAM 123b and the DRAM cache 122. In one embodiment, the control circuit 124 includes the circuitry and structure necessary to interface and process commands and data with both the DRAM 121 and PRAM 123b. In one embodiment, the DRAM cache 122 is omitted and the control circuit 124 serves as an interface between the DRAM 121 and the host (e.g. host 110 of FIG. 1) and between the PRAM 123b and the host.

In one embodiment, the control circuit 124 receives the command CMD, the address ADDR, and the data DATA via the command bus BUS_C, the address bus BUS_A, and the data bus BUS_D respectively, and provides the received command CMD, address ADDR, and data DATA to the DRAM 121 and the DRAM cache 122. In one embodiment, the control circuit 124 provides the command CMD and the address ADDR to the PRAM 123b, and transfers data DATA_NV between the PRAM 123b and the DRAM cache 122. In one embodiment, the virtual and physical address spaces of the host 110, the DRAM 121, the DRAM cache 122, and the PRAM 123b are mapped in a manner similar to that described with FIG. 5

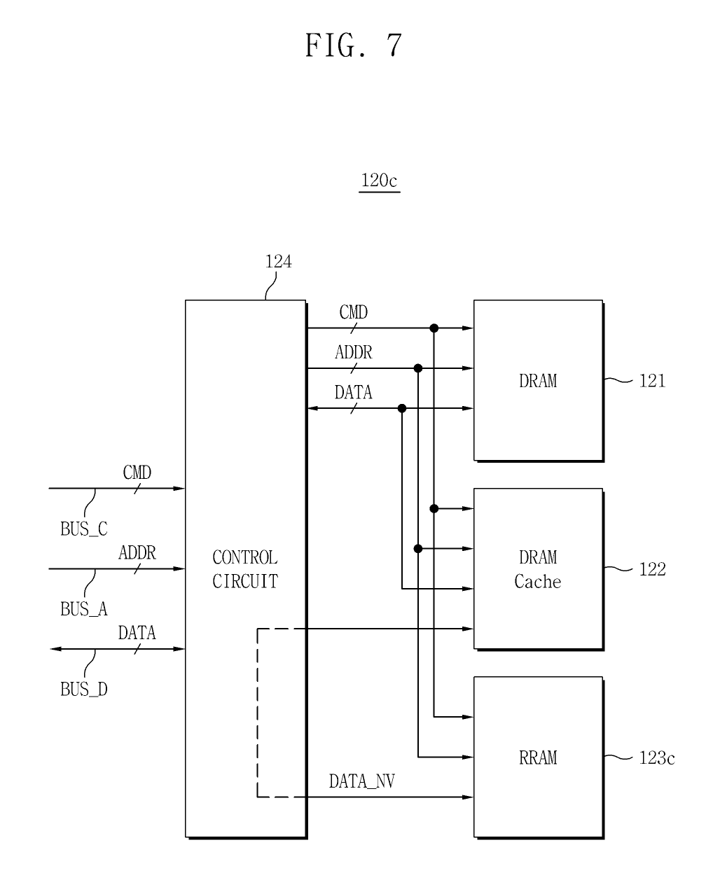

FIG. 7 is a block diagram of another example of a memory device 120c included in the system 100 of FIG. 1.

Referring to FIG. 7, a memory device 120c may include a DRAM 121, a DRAM cache 122, a resistive RAM (RRAM) 123c, and a control circuit 124. In one embodiment, the DRAM 121, the DRAM cache 122, the RRAM 123c, and the control circuit 124 are separate semiconductor chips, and the memory device 120c is an MCP. For example, the DRAM 121 and the DRAM cache 122 may be volatile semiconductor memories, and the RRAM 123c may be a resistive memory device that employs a transition metal oxide as a variable resistance device. In one embodiment, the RRAM 123c is a non-volatile memory device. The control circuit 124 may be an ASIC chip.

In one embodiment, the control circuit 124 serves as an interface between the DRAM 121 and the host (e.g. host 110 of FIG. 1), between the DRAM cache 122 and the host, and between the RRAM 123c and the DRAM cache 122. In one embodiment, the control circuit 124 includes the circuitry and structure necessary to interface and process commands and data with both the DRAM 121 and RRAM 123c. In one embodiment, the DRAM cache 122 is omitted and the control circuit 124 serves as an interface between the DRAM 121 and the host (e.g. host 110 of FIG. 1) and between the RRAM 123c and the host.

In one embodiment, the control circuit 124 receives the command CMD, the address ADDR, and the data DATA via the command bus BUS_C, the address bus BUS_A, and the data bus BUS_D respectively, and provides the received command CMD, address ADDR, and data DATA to the DRAM 121 and the DRAM cache 122. In one embodiment, the control circuit 124 provides the command CMD and the address ADDR to the RRAM 123c, and transfers data DATA_NV between the RRAM 123c and the DRAM cache 122. In one embodiment, the virtual and physical address spaces of the host 110, the DRAM 121, the DRAM cache 122, and the RRAM 123c are mapped in a manner similar to that described with FIG. 5

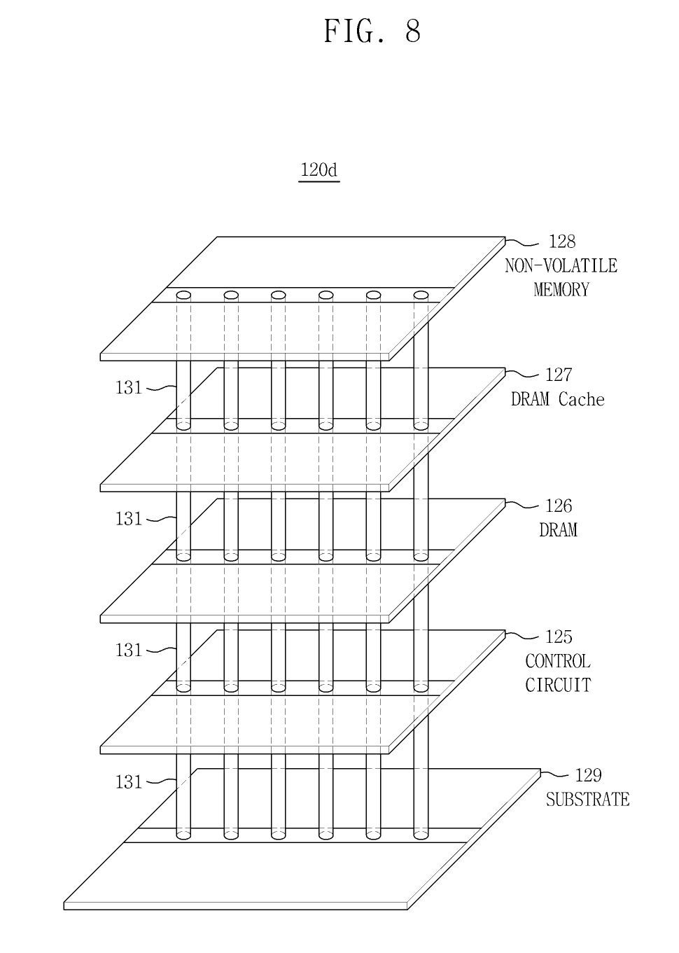

FIG. 8 is a diagram of an example of a memory device 120d included in the system 100 of FIG. 1.

Referring to FIG. 8, a memory device 120d may include a control circuit 125, a DRAM 126, a DRAM cache 127, a non-volatile memory 128, and a substrate 129. In one embodiment, the non-volatile memory 128 may be a flash memory, a PRAM, a RRAM, or any other suitable type of non-volatile memory.

In one embodiment, the memory device 120d of FIG. 8 is a stacked memory device in which the control circuit 125, the DRAM 126, the DRAM cache 127, and the non-volatile memory 128 are three-dimensionally stacked on the substrate 129. In one embodiment, the memory device 120d is implemented in a single multi-chip package. The DRAM 126, the DRAM cache 127, the non-volatile memory 128, and the control circuit 125 may be separate semiconductor chips in the memory device 120d. In one embodiment, the DRAM 126 may comprise one or more stacked semiconductor chips. In one embodiment, the DRAM cache 127 may comprise one or more stacked semiconductor chips. In another embodiment, the non-volatile memory 128 may comprise one or more stacked chips. In one embodiment, the control circuit 125 may be part of one of the other memory chips (e.g. the DRAM 126, the DRAM cache 127, or the non-volatile memory 128).

In one embodiment, as depicted in FIG. 4B, the memory controller 114 may be part of the multi-chip package. In one embodiment, the memory controller 114 may be three-dimensionally stacked on the substrate 129, along with the control circuit 125, the DRAM 126, the DRAM cache 127, and the non-volatile memory 128. The memory controller 114 may be a separate semiconductor chip in the memory device 120d, or may be part of one of the other memory chips (e.g. the DRAM 126, the DRAM cache 127, or the non-volatile memory 128). The memory controller 114 may be on the same chip as the control circuit 125 or may be on a separate semiconductor chip than the control circuit 125.

In one embodiment, the respective layers constituting the stacked memory device 120d (e.g. the semiconductor chips corresponding to the control circuit 125, the DRAM 126, the DRAM cache 127, and the non-volatile memory 128) are electrically connected to each other by means of one or more through substrate vias (TSV) 131, which are interlayer connection units. A through-substrate via may comprise a via penetrating through at least the substrate of a chip (e.g., a crystalline substrate) and may penetrate through the entire chip. When the through-substrate via penetrates through the substrate but not through the entire chip, the chip may also include a wiring connecting the through substrate via to a chip pad or terminal to the top surface of the chip. The through-substrate vias may be through silicon vias when the substrate is silicon (e.g., formed from a crystalline silicon wafer on and/or in which internal circuitry is formed by semiconductor processing). The through-substrate vias may also be formed through other substrates used in semiconductor chip manufacturing, such as silicon-on-insulator, germanium, silicon-germanium, gallium-arsenic (GaAs) and the like.

In one embodiment, one or more of the TSVs 131 are used to communicate specific signals between the control circuit 125 and one or more of the other layers of the stacked memory device 120d. For example, one of the TSVs 131 may be used to communicate a CMD to the DRAM 126, the DRAM cache 127, and the non-volatile memory 128. One of the TSVs 131 may be used to communicate an ADDR to the DRAM 126, the DRAM cache 127, and the non-volatile memory 128. In another example, one of the TSVs 131 may be used to communicate a DATA to the DRAM 126 and the DRAM cache 127. In another example, one of the TSVs 131 may be used to communicate a DATA_NV signal to the DRAM cache 127 and the non-volatile memory 128.

In these examples, a chip select signal may also be communicated along with the respective CMD, ADDR, DATA, and/or DATA_NV to enable receipt of the signal by the DRAM 126, the DRAM cache 127 and/or the non-volatile memory 128. In one embodiment, one or more of the TSVs 131 may be connected to a separate chip select terminal (not shown) on the substrate or the control circuit 125. In one embodiment, the control circuit 125 may include a chip select signal when it communicates to other memory chips in the memory device 120d via one or more of the TSVs 131. The chip select signal may be, for example, a set of bits, such that one bit of the chip select signal indicates whether a respective one of the memories (e.g. the DRAM 126, the DRAM cache 127, and the non-volatile memory 128) is selected to receive the communication from the control circuit 125. When the semiconductor chips are three-dimensionally stacked as shown in FIG. 8, an area occupied by a semiconductor device such as a memory device 120d may be reduced in a system.

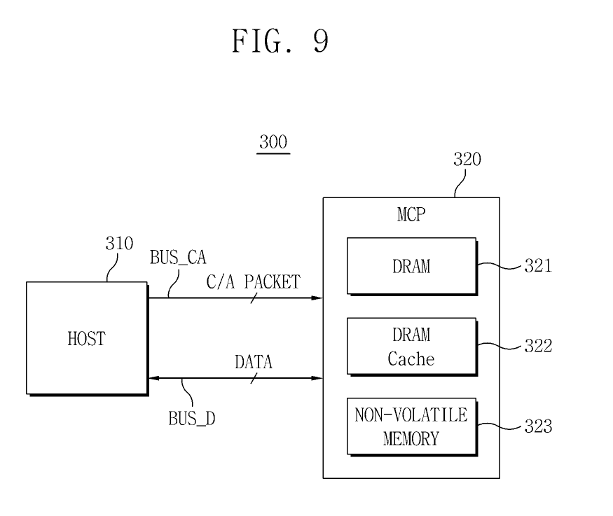

FIG. 9 is a block diagram of a system 300 including an exemplary memory device 320. Referring to FIG. 9, the system 300 includes a host 310 and a memory device 320.

The host 310 generates a command/address packet C/A PACKET, in which a command CMD and an address ADDR are combined, and data DATA. After the command/address packet C/A PACKET and the data DATA from the host 310 are received by the memory device 320 via a command/address bus BUS_CA and a data bus BUS_D respectively, the memory device 320 writes the data DATA to a memory space corresponding to the address ADDR, or reads data from the memory space corresponding to the address ADDR and transmits the read data to the host 310. The memory device 320 may include a DRAM 321, a DRAM cache 322, and a non-volatile memory 323. The memory device 320 may be a multi-chip package.

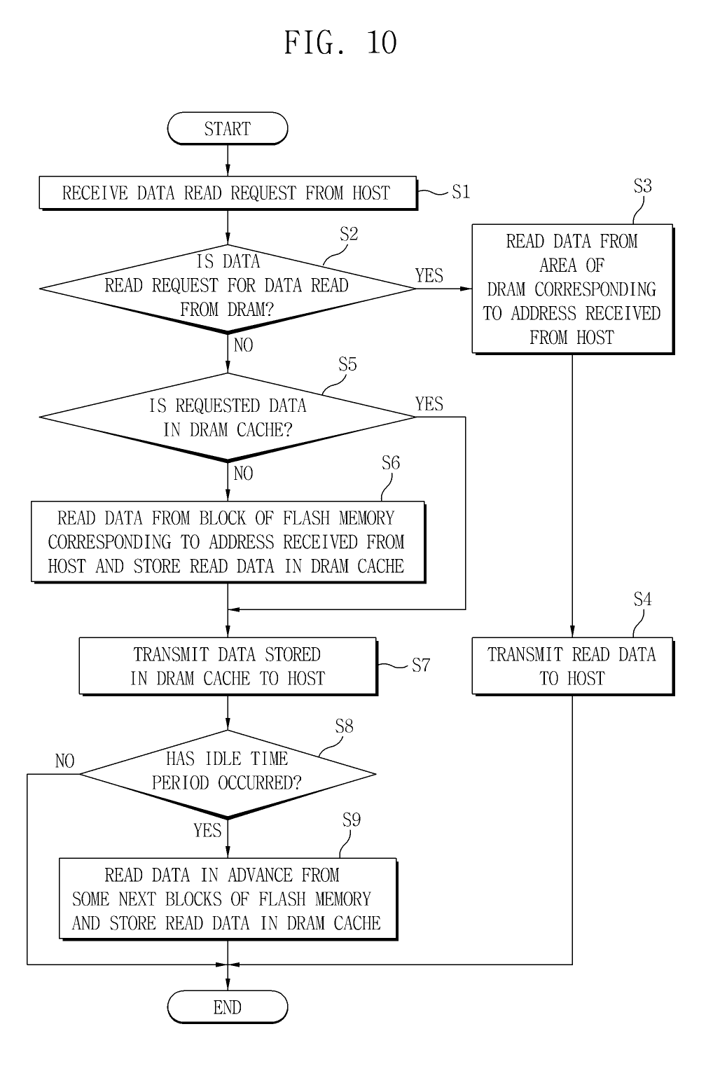

FIG. 10 is a flowchart illustrating a data read method of a memory device according to an example embodiment.

The data read method of an exemplary memory device illustrated in FIG. 10 includes the following operations:

1) The memory device receives a data read request from a host, where the data read request may include an address from the host that corresponds to the data to be read and an amount of data to be read (S1).

2) A controller of the memory device determines whether the data read request is for data to be read from a DRAM or a flash memory (S2). In one embodiment, the controller determines whether the data to be read is for data to be read from a DRAM or from a flash memory based upon the address received from the host. In another embodiment, an indicator is sent with the data read request, which is read by the controller to determine whether data is to be read from the DRAM or the flash memory.

3) When the data read request is for data to be read from the DRAM, the controller reads data from an area of the DRAM corresponding to the address received from the host (S3).

4) The controller then transmits the data read from the corresponding area of the DRAM to the host (S4).

5) When the data read request is for data to be read from the flash memory, the controller determines whether the data to be read from the flash memory has already been loaded in a DRAM cache (S5). In one embodiment, the data to be read corresponds to one or more physical blocks of data in the flash memory, and the controller determines whether the data from the one or more physical blocks of data in the flash memory has already been loaded in the DRAM cache.

In one embodiment, the DRAM cache may only hold data from the flash memory. In this embodiment, the controller looks up an address in the DRAM cache that corresponds to the address of the data to be read from the flash memory, and determines from an address lookup table in the DRAM cache whether the data to be read is loaded on the DRAM cache. For example, the memory device may look up whether an entry exists in an address lookup table (not shown) in the DRAM cache for the address of the data to be read from the flash memory. In one embodiment, the DRAM cache has a separate lookup table for data that had been loaded onto the DRAM cache and data that has not been loaded into the DRAM cache. In this embodiment, if an entry exists in the lookup table for data from the flash memory that has been loaded on the DRAM cache, then the memory device may determine that the data to be read is loaded on the DRAM cache. In another embodiment, the DRAM cache maintains a single lookup table for data stored on the DRAM cache and stored only on the flash memory. In this embodiment, if an entry exists in the lookup table for an address of the data to be read, the controller may read the entry to determine whether the data to be read has been loaded on the DRAM cache or has not yet been stored on the DRAM cache. In this embodiment, the lookup table may include one or more bits that are used to designate whether data at a specific address is stored on the DRAM cache or only on the flash memory.

In another embodiment, the DRAM cache may hold data from the flash memory and from the DRAM. In this embodiment, one lookup table may be used in the DRAM cache, with one or more bits indicating, for each entry, whether the entry for a specific address is associated with data loaded on the DRAM cache from the DRAM, data loaded on the DRAM cache from the flash memory, data stored only at the flash memory, and/or data stored only on the DRAM. In another embodiment, a separate lookup table is used for data associated with the DRAM and data associated with the flash memory. In this embodiment, one or more tables may be used for the data associated with each type of memory, similar to the tables used in an embodiment where the DRAM cache only stores data loaded from the flash memory.

6) When the data to be read has already been loaded in the DRAM cache, the controller transmits that loaded data in the DRAM cache to the host (S7). In one embodiment, the data stored in the DRAM cache is transmitted to the host in word units.

7) When the memory device determines that the data to be read has not been loaded in the DRAM cache, the controller reads the data from one or more blocks of the flash memory that correspond to the address and the amount of data to be read in the data read request, and then stores the data to be read in the DRAM cache (S6). In one embodiment, the lookup tables in the DRAM cache are updated with the loading of data from the flash memory to the DRAM cache.

8) When the data to be read has been stored in the DRAM cache, the controller transmits that stored data in the DRAM cache to the host (S7). In one embodiment, the data stored in the DRAM cache is transmitted to the host in word units.

9) The memory device determines whether an idle time period has occurred (S8). In one embodiment, an idle time period is a specified period of time in which the memory device has not received any external requests. In some embodiments, the memory device waits for an idle time period to occur, and then engages in internal processing, such as garbage collection, updating the cache of the memory device, and other suitable memory management processes. In one embodiment, the memory device may maintain a separate idle time period for the DRAM and the flash memory. In this embodiment, the DRAM may experience an idle period while the controller interfaces with the flash memory and the DRAM cache. Similarly, the flash memory may experience an idle period while the controller interfaces with the DRAM.

10) When an idle time period has occurred for the flash memory, the memory device reads data in advance from one or more blocks next to the one or more blocks of the flash memory that were just read from the controller, and stores the read data in the DRAM cache (S9). In one embodiment, the data is read in advance from the flash memory without an explicit data read request from the host. In one embodiment, the lookup table in the DRAM cache is updated upon the loading of data from the flash memory onto the DRAM cache.

In one embodiment, the amount of data read and stored in advance into the DRAM cache is the amount of data that was requested in the read request received from the host. In one embodiment, the amount of data read and stored in advance into the DRAM cache corresponds to the amount of free space in the DRAM cache. In another embodiment, the amount of data read and stored in advance into the DRAM cache is the amount of data that corresponds to the oldest read request from the host for which data is stored in the DRAM cache. In this embodiment, the data read in advance from the flash memory replaces the data in the DRAM cache that corresponds to the oldest read request from the host for which data is stored in the DRAM.

In one embodiment, the controller is the control circuit 124 in any of the exemplary memory devices described herein. For example, the memory device is the memory device 120. The memory device is not limited to the embodiments described herein. Similarly, the DRAM, the DRAM cache, and the flash memory may be any of the exemplary devices described herein, but are not limited to the examples described herein.

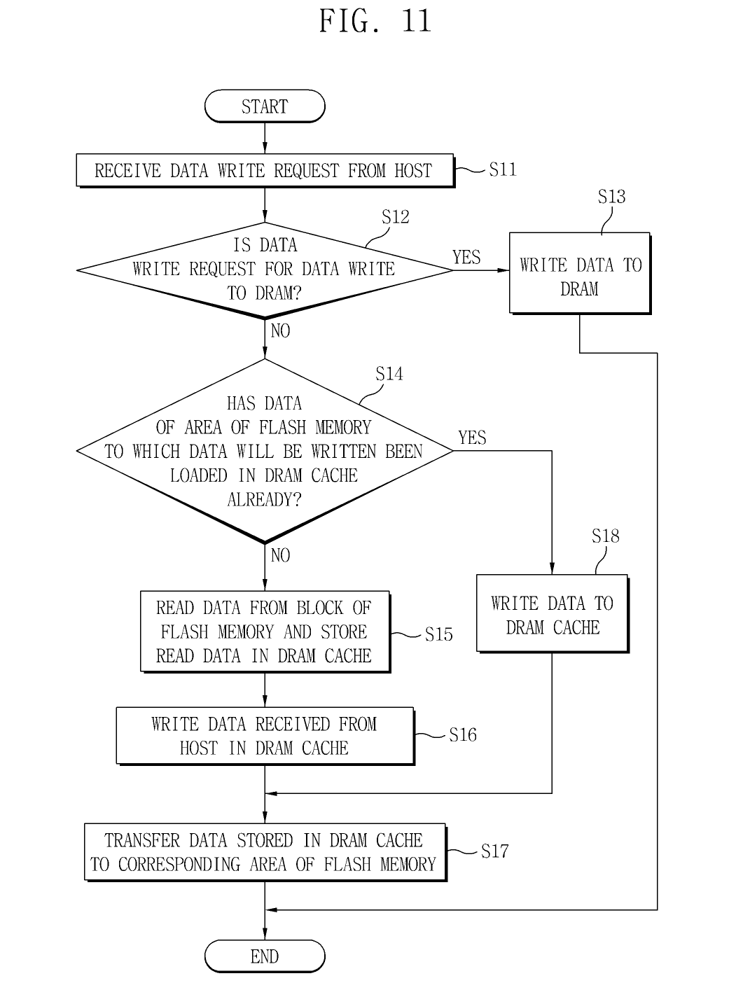

FIG. 11 is a flowchart illustrating a data write method of an exemplary memory device according to an example embodiment. In one embodiment, the controller and memory device of FIG. 11 is similar to the controller and memory device of FIG. 10.

The data write method of an exemplary memory device illustrated in FIG. 11 includes the following operations:

1) The controller of the memory device receives a data write request from a host, where the data write request may include data to be written. The data write request also includes an indicator that indicates to which memory the data is to be written (S11). In one embodiment, the indicator is a memory address that corresponds to a physical location in either the DRAM or the flash memory. In one embodiment, the indicator includes one or more bits that refer to either the DRAM or the flash memory.

2) The controller determines whether the data write request is to data write to a DRAM or a flash memory (S12). In one embodiment, the memory device determines whether the data write request is to write data to the DRAM or the flash memory based upon the indicator sent in the data write request. If the indicator is a memory address, the controller determines whether to write the data to the flash memory or the DRAM based upon the memory address. If the indicator included one or more bits, the controller determines whether the data write request is to write data to the DRAM or the flash memory based on the bits in the indicator.

3) When the data write request is to data write to the DRAM, the controller writes data to an area of the DRAM (S13). In one embodiment, the indicator in the data write request is an address in the DRAM to which to write the write data, and the controller writes the write data to the received address. In another embodiment, the controller writes the write data to a next available address in the DRAM based upon the free space available in the DRAM. In one embodiment, when there is no free space in the DRAM, the controller may write the data to the DRAM based upon various methods of determining to where to write new data in a full memory device. For example, the controller may replace the oldest written data in the DRAM with the new write data or the controller may replace the least accessed data in the DRAM with the new write data. The method by which the controller determines where in the DRAM to write the write data if an address is not provided is not limited by the examples herein.

4) When the data write request is to write data to the flash memory and the data write request includes an address to which the write data was to be written, the controller determines whether data from an area of the flash memory corresponding to the write address has already been loaded in a DRAM cache (S14). The determination of whether data corresponding to an address in the flash memory has been loaded in the DRAM cache may be similar to the determination described above with respect to FIG. 10.

5) When the data corresponding to the address in flash memory to which the data will be written has not been loaded in the DRAM cache, the controller reads data from one or more blocks of the flash memory corresponding to the write address received from the host, and stores the data read from the flash memory in the DRAM cache (S15). In one embodiment, the lookup tables in the DRAM cache are updated with the loading of data from the flash memory to the DRAM cache.

6) When the data of the area of the flash memory to which the data will be written has been loaded in the DRAM cache, the controller writes the data to an area of the DRAM cache corresponding to the address received from the host in the data write request (S16).

7) When the data corresponding to the address in flash memory to which data will be written has already been loaded in the DRAM cache, the controller writes the data received from the host to the area of the DRAM cache corresponding to the address received from the host in the data write request (S18).

8) When the space of the DRAM cache is full and/or swapped out, or an additional enable signal is applied, the controller may transfer the data stored in the DRAM cache to an area of the flash memory corresponding to the address received from the host in the data write request (S17).

In one embodiment, the memory device only reads and writes data from the host to the flash memory via the DRAM cache when data from the flash memory has been loaded to the DRAM cache. In this embodiment, the DRAM cache may store the most current version of data in the flash memory for the addresses for which data from the flash memory is loaded in the DRAM cache. For example, the data loaded in the DRAM cache that corresponds to an area in the flash memory may be more current than the data stored in that area of the flash memory. In one embodiment, when data is transferred from the DRAM cache to the flash memory, only data that has been loaded in the DRAM cache and then modified may be transferred from the DRAM cache to the flash memory. By only transferring modified data, the amount of data to be transferred from the DRAM cache to the flash memory would be reduced and the transfer operation would be more efficient.

In one embodiment, when the DRAM cache is full, the memory device may transfer the data stored in the DRAM cache to the areas of flash memory from which the data in the DRAM cache was loaded. For example, if data corresponding to an address in the flash memory was loaded in the DRAM cache, and the DRAM cache is full, the data in the DRAM cache that corresponds to that address will be transferred to the flash memory. In one embodiment, after the data has been transferred from the DRAM cache to the flash memory, all of the data in the DRAM cache may be deleted and the DRAM cache may be empty.

In another embodiment, the DRAM cache may transfer all of its data to the flash memory after the first time it becomes full. In this embodiment, the DRAM cache does not delete the data from the flash memory after it has been loaded and/or modified. Instead, the DRAM cache may periodically transfer data that has been loaded from the flash memory and then modified, or may periodically transfer all of its data to the flash memory. For example, the DRAM cache may transfer data to the flash memory after a certain number of read or write requests from the host. In another example, the DRAM cache may store one or more swap bits that indicate whether the associated data has been transferred in the last transfer of data to the DRAM cache, and may update the swap bits associated with the data after each transfer of data to the DRAM cache. In this example, the DRAM cache may only transfer data whose swap bits indicate that the associated data was not transferred to the flash memory in the last transfer of data from the DRAM cache to the flash memory.

In one embodiment, the memory device may use the swap bits to determine where to load data from the flash memory in the DRAM cache during a data read or data write operation. In one embodiment, when transferring data from the DRAM cache to the flash memory, the DRAM cache may act as a swap cache that undergoes block replacement, similar to the shared cache in U.S. Pat. No. 5,692,149, which is incorporated herein in its entirety by reference. In this embodiment, the DRAM cache and the flash memory may act as a combined cache and local memory, with the DRAM cache as the cache and the flash memory as the local memory. In this embodiment, the data that replaces the existing data in the DRAM cache is data loaded from the flash memory in correspondence with a read or write request from the host. The methods of transferring data from the DRAM cache to the flash memory are not limited to those described herein.

In one embodiment, when an enable signal is received from the host or applied to the DRAM cache, the data in the DRAM cache is transferred to the flash memory. As mentioned above, in some embodiments, only modified data is transferred to the flash memory. In some embodiments, only data whose swap bits indicate that the data was not transferred during the last transfer of data is transferred from the DRAM cache to the flash memory. In some embodiments, all of the data in the DRAM cache is transferred to the flash memory. In some embodiments, other suitable methods of transferring data from the DRAM cache to the flash memory are also applicable. The type of method used to determine when and what data to transfer from the DRAM cache to the flash memory is not limited to the examples described herein.

As mentioned above, in one embodiment, the controller is the control circuit 124 in any of the exemplary memory devices described herein. For example, the memory device is the memory device 120. The memory device, however, is not limited to the embodiments described herein. Similarly, the DRAM, the DRAM cache, and the flash memory may be any of the exemplary devices discussed herein, but are not limited to those described herein.

A memory device according to various embodiments may have a simple data read/write process because a virtual address space of a CPU of a host is related to a physical address space of a non-volatile memory, with the virtual addresses in the virtual address space of the CPU in a 1:1 correspondence with the physical addresses in the physical address space of the non-volatile memory. Also, since the physical address space of the non-volatile memory and the physical address space of a DRAM may be controlled using only a single memory controller, without needing an additional memory controller for controlling the non-volatile memory, the number of balls for electrically connecting memory controllers with an external device included in the package of the memory device may be reduced. Further, the physical address space of the non-volatile memory may not need to be accessed for data loaded in a DRAM cache, and thus latency may be reduced. Furthermore, since the number of times of programming/erasing the non-volatile memory may be reduced, the life of the memory device may be increased. Accordingly, an example memory device may be small in size, with a high operating speed and low production cost.

Embodiments of the present disclosure can be applied to an apparatus and system employing an multi-chip package.

The above-disclosed subject matter is to be considered illustrative and not restrictive, and the appended claims are intended to cover all such modifications, enhancements, and other embodiments, which fall within the true spirit and scope of the disclosed embodiments. Thus, the invention is to be determined by the broadest permissible interpretation of the following claims and their equivalents, and shall not be restricted or limited by the foregoing detailed description.

What is claimed is:

1. A memory device, comprising:
a non-volatile memory;
a dynamic random access memory (DRAM) cache;
a DRAM; and
a control circuit configured to perform interfacing between the DRAM and a host, between the DRAM cache and the host, and between the non-volatile memory and the DRAM cache,
wherein the memory device is a stacked memory device in which the non-volatile memory, the DRAM cache, and the DRAM are three-dimensionally stacked.

2. The memory device of claim 1, wherein the memory device is a memory module implemented by a multi-chip package (MCP).

3. The memory device of claim 1, wherein the non-volatile memory, the DRAM cache, and the DRAM are electrically connected to each other through at least one through substrate via (TSV).

4. The memory device of claim 1, wherein the control circuit is configured to map a physical address space of the DRAM to a virtual address space of the host.

5. The memory device of claim 1, wherein the control circuit is configured to map a physical address space of the non-volatile memory to a virtual address space of the host through a physical address space of the DRAM cache.

6. The memory device of claim 1, wherein when a data read request is received from the host, the control circuit is configured to determine whether the data read request is for data to be read from the DRAM or the non-volatile memory.

7. The memory device of claim 6, wherein when the data read request received from the host is for data to be read from the DRAM, the control circuit is configured to read data from an area of the DRAM corresponding to an address received from the host, and to transmit the read data to the host.

8. The memory device of claim 6, wherein when the data read request received from the host is for data to be read from the non-volatile memory, the control circuit is configured to determine whether data stored in a block of the non-volatile memory corresponding to an address received from the host has been loaded in the DRAM cache,
when the data stored in the block of the non-volatile memory has been loaded in the DRAM cache, the control circuit is configured to transmit the data stored in the DRAM cache to the host, and
when the data stored in the block of the non-volatile memory has not been loaded in the DRAM cache, the control circuit is configured to read data from the block of the non-volatile memory corresponding to the address received from the host, to store the data read from the block of the non-volatile memory in the DRAM cache, and to transmit the data stored in the DRAM cache to the host.

9. The memory device of claim 1, wherein when a data write request is received from the host, the control circuit is configured to determine whether the data write request is for write data to be written to the DRAM or the non-volatile memory.

10. The memory device of claim 9, wherein when the data write request received from the host is for write data to be written to the DRAM, the control circuit is configured to write data to an area of the DRAM corresponding to an address received from the host.

11. The memory device of claim 9, wherein when the data write request received from the host is for write data to be written to the non-volatile memory, the control circuit is configured to determine whether data stored in an area of the non-volatile memory to which write data will be written has already been loaded in the DRAM cache.

12. The memory device of claim 11, wherein when the data stored in the area of the non-volatile memory to which the write data will be written has not been loaded in the DRAM cache, the control circuit is configured to read the data stored in a block of the non-volatile memory corresponding to an address received from the host, and to store the data read from the block of the non-volatile memory in the DRAM cache.

13. The memory device of claim 11, wherein when the data stored in the area of the non-volatile memory to which write data will be written has been loaded in the DRAM cache, the control circuit is configured to write the write data in an area of the DRAM cache corresponding to an address received from the host, and
when no space is available in the DRAM cache, or an enable signal is received, the control circuit is configured to transfer data stored in the DRAM cache to an area of the non-volatile memory corresponding to the address received from the host.

14. A system comprising a host and a memory device, wherein the memory device includes:
a non-volatile memory;
a dynamic random access memory (DRAM) cache;
a DRAM; and
a control circuit configured to perform interfacing between the DRAM and the host, between the DRAM cache and the host, and between the non-volatile memory and the DRAM cache,
wherein the memory device is a stacked memory device in which the non-volatile memory, the DRAM cache, and the DRAM are three-dimensionally stacked.

15. A multi-chip memory device package comprising:
a dynamic random access memory (DRAM);
a non-volatile memory; and
a first controller configured to:
receive a physical address and a command; and
determine whether to interface with the DRAM or the non-volatile memory based on the received physical address,
wherein:
each virtual address in a first part of a virtual address space of a host corresponds to a respective physical address in a physical address space of the DRAM, and
each virtual address in a second part of the virtual address space of the host corresponds to a respective physical address in a physical address space of the non-volatile memory.

16. The package of claim 15, further comprising:
a DRAM cache connecting the flash memory and the controller, wherein the first controller is further configured to:
store data from the non-volatile memory in the DRAM cache, the data corresponding to the received physical address and the command, and
process data in one of the DRAM and the DRAM cache based on the received physical address.

17. The package of claim 16, wherein, when the received physical address is in the physical address space of the non-volatile memory, the first controller is configured to:
determine if the DRAM cache stores data corresponding to the received physical address in the non-volatile memory, and
store data from the non-volatile memory in the DRAM cache if the DRAM cache does not store data corresponding to the received physical address,
wherein:
each of the physical addresses in the physical address space of the DRAM cache is in the physical address space of the non-volatile memory.

18. The package of claim 15, wherein the first controller is further configured to:
receive a virtual address and the command from the host; and
translate the virtual address into a physical address.

19. The package of claim 15, wherein the first controller is further configured to:
perform error correction on data that is read from the DRAM and the non-volatile memory.
